(19) United States
(12) Patent Application Publication
(10) Pub. No.: US 2015/0302890 A1
(43) Pub. Date: Oct. 22, 2015

(54) PAUSING AND RESUMING MEDIA PLAY

(71) Applicant: ECHOSTAR TECHNOLOGIES L.L.C., ENGLEWOOD, CO (US)

(72) Inventors: Charles W. Ergen, Englewood, CO (US); Danny J. Minnick, Littleton, CO (US)

(73) Assignee: ECHOSTAR TECHNOLOGIES L.L.C., ENGLEWOOD, CO (US)

(21) Appl. No.: 14/255,229

(22) Filed: Apr. 17, 2014

(51) Int. Cl. G11B 27/00; H04N 21/6587; H04N 5/783; H04N 21/2387; H04N 5/85; G11B 27/10

(52) U.S. Cl. CPC G11B 27/005; H04N 5/85; G11B 27/105; H04N 5/783; H04N 21/2387; H04N 21/6587

(57) ABSTRACT

A request to play a second item of media content is received while playing a first item of media content. A determination is made whether a location for resuming play of the second item of media content is stored. If a location for resuming play of the second item of media content is stored, play of the second item of media content is resumed at the location in the second item of media content. If a location for resuming play of the second item of media content is not stored, play of the second item of media content is begun at a current location in the second item of media content.

### BACKGROUND

Media content producers may provide items of media content, e.g., television programs, movies, videos, sporting events, political events, etc., to a large number of consumers, e.g., via a broadcast, web downloads, etc. Often, e.g., in the case of events being presented “live,” i.e., for viewing in real-time or near real-time, a user may wish to view items of media content being streamed simultaneously. However, a user toggling between two items of media content risks missing a portion or portions of the media content.

### DRAWINGS

FIG. 1 is a block diagram of an exemplary media content delivery system.

FIG. 2 is a block diagram of an example of items media content provided simultaneously from a media source, and accessed alternatively via a media device.

FIG. 3 is a block diagram of another example of items of media content provided simultaneously from a media source, and accessed alternatively via a media device.

FIG. 4 is a block diagram of an example of items of media content provided simultaneously from a media source, and accessed alternatively via a media device, at least one of the items of media content including a hop portion.

FIG. 5 is a diagram of an exemplary process for simultaneously accessing, including pausing and/or resuming play of, multiple items of media content.

### DETAILED DESCRIPTION

### Introduction

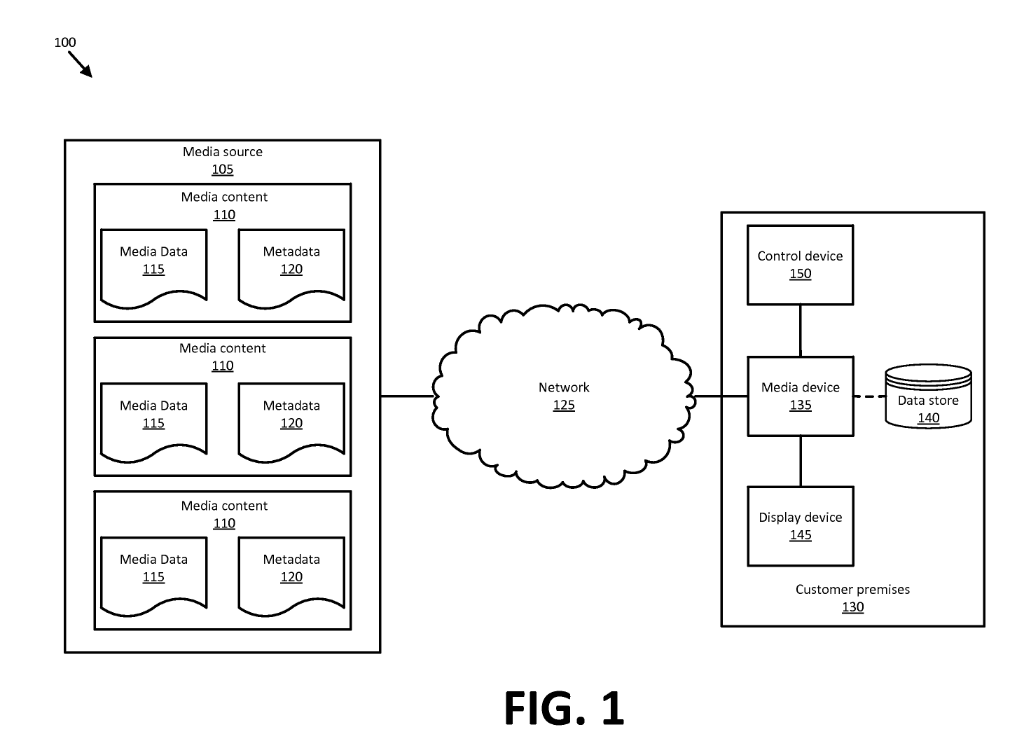

FIG. 1 is a block diagram of an exemplary media content delivery system 100. Within the context of the system 100, playback of two or more items of media content 110 may be advantageously managed in a media device 135. For example, a user viewing a first item of media content 110 could elect to begin playback of a second item of media content 110, whereupon the media device 135 marks a location in the first item of media content 110 at which playback of the first item of media content 110 has been paused. Further, as the media device 135 continues to receive a stream of the first item of media content 110, the media content 110 data is generally stored in a data store 140, e.g., a buffer or the like, included in or communicatively coupled to the media device 135. The user could then elect to return to playback of the first item of media content 110, whereupon the media device 135 may be configured to resume playback of the first item of media content 110 at the marked location.

Alternatively, the media device 135 could be configured to resume playback of the first item of media content at some other location, e.g., a location after the marked location and after a commercial break or other interruption in the first item of media content has ended. Further, upon resuming playback of the first item of media content 110, the media device 135 could mark a location in the second item of media content 110 at which playback of the second item of media content 110 has been paused. Yet further, the media device 135 may be configured to mark locations in, and allow a user to toggle between views of, more than first and second items of media content 110, i.e., between three or more items of media content 110.

Accordingly, a media source 105 in the system 100 includes multiple items of media content 110, e.g., streaming content such as a video presentation such as a movie, television program, sporting events, political event, video clip, etc. The media content 110, generally including media data 115 and metadata 120, may be provided via a network 125 to a media device 135 that is generally located in a customer premises 130. It should be noted that, although a single media source 105 and a single customer premises 130 are shown in FIG. 1 for ease of illustration, the system 100 could, and generally does, include multiple media sources 105 and multiple customer premises 130. In any event, the media content 110 streamed to a device 135 in a customer premises 130 may be stored in the data store 140 in addition to being provided for viewing via a display device 145. A user may use a control device 150 to access an item of media content 110, toggle between items of media content 110, etc.

### Exemplary System Elements

### Media Source

In general, a media source 105 may be any one or some combination of various mechanisms for delivering media content 110, e.g., one or more computing devices and storage devices, and may depend on a type of media content 110 being provided. Accordingly, a media source 105 may include multiple elements for processing, storing, and providing media content 110 and related data. Elements of the media source 105 may be local to one another and/or may be distributed amongst multiple locations. For example, media source 105 may include one or more computer servers (some or all of which may be referred to as “media servers”) and data storage devices, e.g., for storing and processing content 110 and other data such as discussed herein.

By way of example and not limitation, media content 110 data may be provided as video-on-demand through a cable, satellite, or internet protocol television (IPTV) distribution system, as streaming Internet video data, or as some other kind of data. Accordingly, the media source 105 may include one or more of a cable or satellite television headend, a video streaming service that generally includes a multimedia web server (or some other computing device), or some other mechanism for delivering multimedia data. In general, examples of media content 110 include various types of data, including audio, video, images, etc.

Media content 110 is generally delivered via the network 125 in a digital format, e.g., as compressed audio and/or video data. The media content 110 generally includes, according to such digital format, media data 115 and media metadata 120. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 110 may be provided in a format such as the MPEG-1, MPEG-2 or the H.264/MPEG-4 Advanced Video Coding standards (AVC) (H.264 and MPEG-4 at present being consistent), or according to some other standard or standards. For example, media content 110 could be audio data formatted according to standards such as MPEG-2 Audio Layer III (MP3), Advanced Audio Coding (AAC), etc. Further, the foregoing standards generally provide for including metadata, e.g., media metadata 120, along with media data 115, in a file or stream of media content 110, such as the media metadata 120 discussed herein that includes indices, tags, etc., to identify locations, e.g., frames, in media data 115.

Media content 110 provided from a media source 105 includes media content as it is usually provided for general distribution, e.g., a movie, television program, sporting event, video file, audio file, etc., in a format that is provided to the media source 105 by a distributor of the media content 110. A distributor of media content 110 may be a movie studio, a television network, etc. Alternatively or additionally, media content 110 may be modified from the format provided by a general distributor of content (e.g., recompressed, re-encoded, etc.).

The media data 115 includes data by which a display, playback, representation, etc. of the media content 110 is presented on a media device 135 and/or display device 145. For example, media data 115 generally includes units of encoded and/or compressed video data, e.g., frames of an MPEG file or stream.

Media metadata 120 may include metadata as provided by an encoding standard such as an MPEG standard. Alternatively and/or additionally, media metadata 120 could be stored and/or provided separately to a media device 135, apart from media data 115. In general, media metadata 120 provides indices to locations, e.g., respective units, e.g., frames, of media data 115, and/or general descriptive information for an item of media content 110. Examples of media metadata 120 include frame numbers or the like for media data 115, tags or other descriptors associated with various frames, as well as information such as content 110 title, chapter, actor information, Motion Picture Association of America MPAA rating information, reviews, and other information that describes an item of media content 110. Information for metadata 120 may be gathered from a content producer, e.g., a movie studio, media information aggregators, and other sources such as critical movie reviews. In some cases, media metadata 120 identifies locations in media data 115, e.g., frames, where interruptions, e.g., commercial advertisements and the like, begin and end. In general, when determining or identifying a location in a stream of media content 110 is disclosed herein, such determining and/or identifying may be performed according to an index and/or tag in metadata 120 of the stream of media content 110. Network

Communications to and from the media source 105 and customer premises 130 may occur via the network 125. In general, the network 125 represents one or more mechanisms for delivering content 110 from the media source 105 to a media device 135. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, etc. Customer Premises

Turning to the customer premises 130, the media device 135 is generally a device including a computer processor and associated storage, e.g., volatile memory, nonvolatile memory, etc., and capable of communicating via the network 125. Exemplary media devices 135 include a set-top box, a personal computer such as a laptop, handheld, or tablet computer, a smart phone, etc. In general, a media device 135 is any device capable of receiving a plurality of streams of media content 110, e.g., a set-top box or television with multiple tuners, e.g., for receiving channels of media content 110 from a media source 105 via a satellite transponder or cable network RF signal, a computing device capable of receiving multiple streams or items of media content 110, etc.

The media device 135 may include and/or may be communicatively coupled to a data store 140, i.e., one or more computer-readable media such as a memory, a hard disk drive, etc. The data store 140 may include one or more buffers for storing items of media content 110 streamed from a media source 105. For example, in one implementation, the data store 140 includes a plurality of buffers, where each respective buffer is provided for a respective tuner included in the media device 135.

The media device 135 generally further includes a display and/or may be connected to a display device 145, e.g., a television, or may incorporate a display device 145, e.g., a display of a personal computer. Alternatively, the media device 135 and display device 145 could be included in a single unit, e.g., a television set or the like including a memory, a processor, tuners, etc., for carrying out operations described herein, including receiving and displaying media content 110. When content 110 is referred to herein as being “played” or “displayed,” it is to be understood that such display could include any possible mode of displaying media data, such as a display of visual data, audio data, etc. For example, content 110 could be displayed by showing video or image data on a screen with or without sound, by playing audio data with or without a visual display, etc.

A control device 150 may be a conventional remote control or the like used to access a set-top box and/or television media device 135. Alternatively or additionally, the control device 150 could include a keyboard, keypad, touchscreen, etc. of a computer media device 135.

### Exemplary Media Device Operations

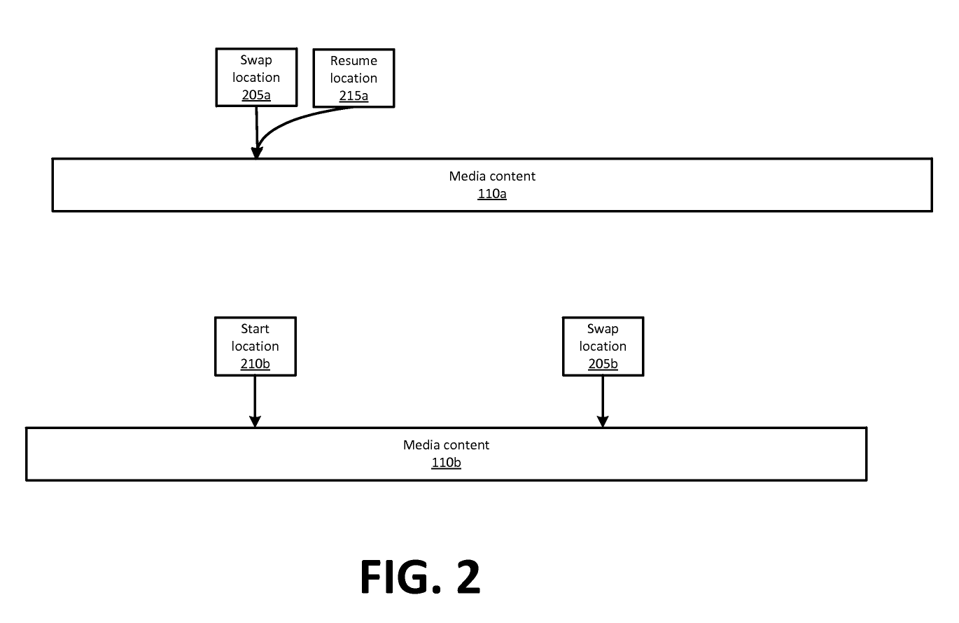

FIG. 2 is a block diagram of items of media content 110a, 110b, provided simultaneously from a media source 105, and accessed alternatively via a media device 135. A first stream of media content 110a may be received from a media source 105, and provided by a media device 135 to a display 145. When the stream of media content 110a has reached a swap location 205a (sometimes also referred to as a pause location 205a because it is a location at which play of the media content 110a has been paused), the media device 135 may receive an input from a control device 150 to access a second stream of media content 110b, e.g., a second channel. Accordingly, the media device 135 may store, i.e., according to an index or the like in metadata 120, a location in the media content 110a, herein referred to as the swap location 205a, when the request to switch from the first item of media content 110a to the second item of media content 110b was received in the media device 135.

The second item of media content 110b includes a start location 210b, which is generally a current location in the second stream of media content 110b, i.e., according to an index or the like in metadata 120 for the item of media content 110b. That is, the start location 210b is generally determined according to a time when the media device 135 receives a request, e.g., from a control device 150, to pause the first stream of media content 110a and a few the second stream of media content 110b. The media device 135 may play the media content 110b until a swap location 205b in the second item of media content 110b is reached.

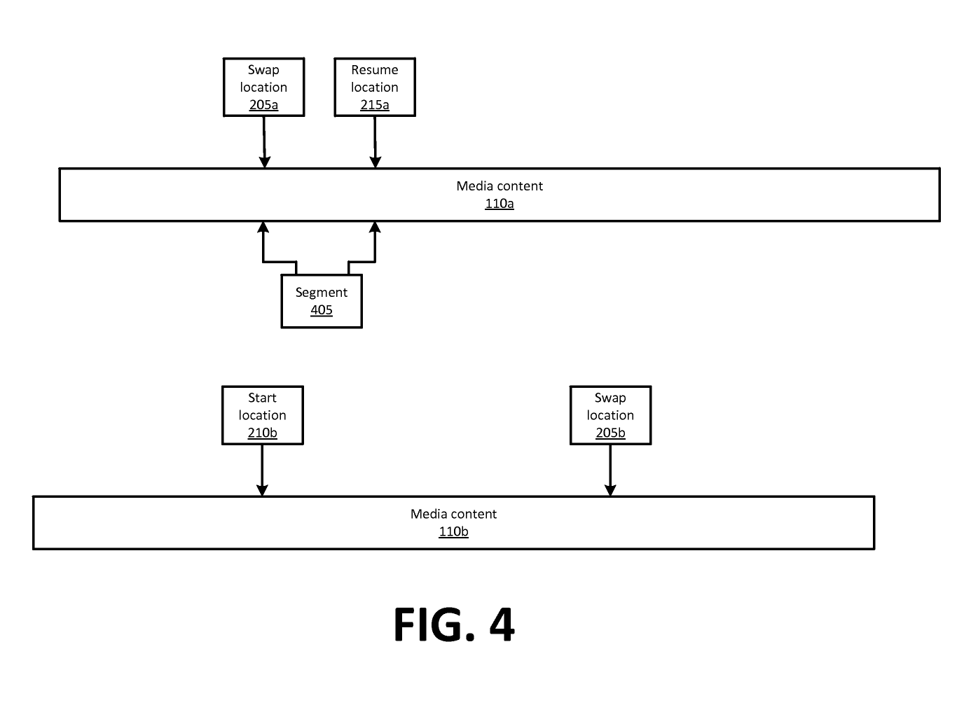

The swap location 205b may be determined in any one of a variety of manners. In one instance, the media device 135 may receive input, e.g., via the control device 150, to switch from the second item of media content 110b back to the first item of media content 110a. For example, the input from a device 150 may indicate to change from a second channel to a first channel being displayed in the display 145. In such instance, the media device 135 may record the swap location 205b, generally an index included in the metadata 124 the media content 110b, and then resume displaying the first item of media content 110a at a resume location 215a, as discussed further below. In another instance, discussed further with respect to FIG. 4 below, a swap location 205b may be determined when the media device 135 determines that the first stream of media content 110a has reached an end of a hop portion 405, e.g., an end of a commercial interruption or the like.

As illustrated in FIG. 2, a resume location 215a, may be a same location, e.g., a same index, in the media content 110a as the swap location 205a described above. In general, as mentioned above, a stream of media content 110a is generally stored in a buffer or the like of the data store 140 as it is received from the media source 105. Accordingly, when input is received in the media device 135 to swap a first stream of media content 110a for a second stream of media content 110b, the media device 135 continues to store the first stream of media content 110a in the data store 140. When input is received in the media device 135 to return to the first stream of media content 110a, i.e., because the swap location 205b is identified in a second stream of media content 100b, it may be desired to resume playback of the first stream of media content 110a at the point at which playback was paused, i.e., the swap location 205a. Accordingly, the resume location 215a may be determined according to the swap location 205a.

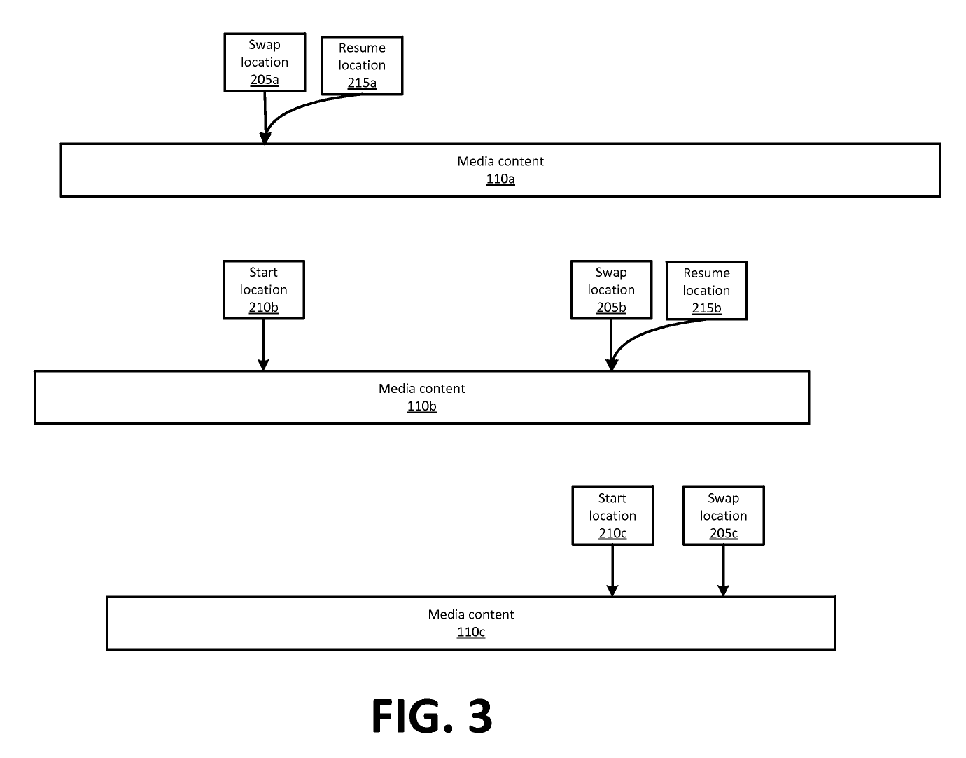

FIG. 3 is a block diagram of items of media content 110a, 110b, 110c provided simultaneously from a media source 105, and accessed alternatively via a media device 135. FIG. 3 is similar to FIG. 2, with the addition of an item of media content 110c. Accordingly, FIG. 3 illustrates a scenario under which a media device 135 is used to toggle between more than two items of media content 110; it should be understood that there is no theoretical limit to a number of items of media content 110 that may be included in the system 100. However, there are practical limits imposed by hardware limitations, usability limitations, etc. For example, in one implementation, a media device 135 includes five tuners, each receiving a stream of media content 110, whereby the media device 135 may be used to toggle up to five streams of media content 110.

The item of media content 110c includes a start location 210c that is assigned at a same time as a swap location 205b is assigned in the item of media content 110b. That is, the media device 135 may receive input to swap from the item of media content 110b to the item of media content 110c, whereupon the swap location 205b is assigned in the item of media content 110b, and the start location 210c is assigned in the item of media content 110c. Further, the media content 110c may include a swap location 205c, whereupon the media device 135 may assign a new start location 210 in yet a fourth item of media content 110 (not shown in FIG. 3), or may return the display 145 to a resume location 215a or 215b in the media content 110a or 110b.

FIG. 4 is a block diagram of items of media content 110 provided simultaneously from a media source 105, and accessed alternatively via a media device 135, at least one of the items of media content including a hop portion 405. Accordingly, the media device 135 may determine a swap location 205a in an item of media content 110a, and may swap or toggle the display 145 to a stream of media content 110b, beginning at a start location 210b in the media content 110b. However, upon receiving input to toggle or swap a view back to a first item of media content 110a, instead of returning to a resume location 215a that is the same as the swap location 205a, the resume location 215a may be determined by identifying a hop portion 405 of the media content 110a. For example, metadata 120 in the media content 110a may indicate that a particular portion of the content 110a includes an interruption, e.g., a commercial break, from regular programming. For example, the metadata 120 could provide tags or the like for beginning and ending units, e.g. frames, of a hop portion 405. It may be desirable, when returning to the programming provided in the stream of media content 110a, to resume playback at a point at which the interruption, e.g. commercial break, ends, and the regular programming resumes.

The media device 135 could be configured to determine if a hop portion 405 is present in the media content 110a and coincides with a selection to swap display of a first item of media content 110a to a second item of media content 110b. That is, if the hop portion 405 is present in the first item of media content 110a, the media device 135 may determine whether streaming of the hop portion 405 is occurring at a same time as playback of a second item of media content 110b for which the media device 135 has received input to swap for the first item of media content 110a. If a hop portion 405 exists and is being streamed, the media device 135 could further be configured to locate a resume location 215a at an end location of a hop portion 405.

Moreover, the media device 135 could return the display 145 to the first item of media content 110a, without user input, upon determining that an end location of the hop portion 405 had been reached in the first item of media content 110a. Alternatively, as mentioned above, the media device 135 could return the display 145 to the first item of media content 110a upon receiving user input to do so, and could be configured to resume playback of the first item of media content 110a at an end location of the hop portion 405. Further alternatively or additionally, the media device 135, upon receiving user input to return to the first item of media content 110a, could request user input concerning where to identify a resume location 215, e.g., whether to resume playback at a swap location 205a or at an end location of the hop portion to 405, and then could determine the start location 210a accordingly.

### Exemplary Process Flow

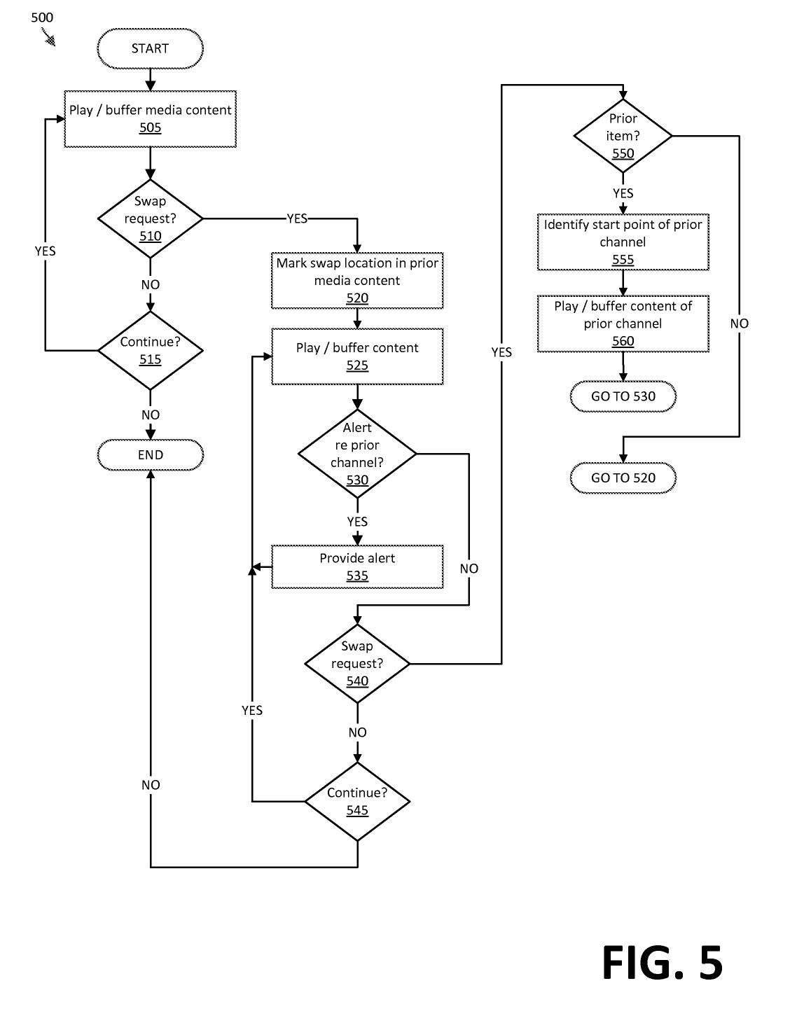

FIG. 5 is a diagram of an exemplary process 500 for simultaneously accessing, including pausing and/or resuming play of, multiple items of media content.

The process 500 begins in a block 505, in which the media device 135 plays a first item of media content 110. For example, as mentioned above, the media device 135 could be a set top box or television including a tuner configured to receive a channel of media content 110. Alternatively, the media device 135 could be a computing device streaming media content 110 via elements of the network 120 including the Internet. In any event, in addition to playing the media content 110 on the display 145, the media device 135 also stores media content 110 in the data store 140, e.g., in a buffer or the like. A buffer in the data store 140 may be dedicated to a stream or channel of media content 110, and may further include sufficient room to store a predetermined amount of media content 110 data.

Following the block 505, in a block 510, the media device 135 determines whether input has been received to view a second item of media content 110. For example, a user may select a new channel of media content 110, select a dedicated key such as a “swap” key or the like, or otherwise provide such input via a control 150, an input mechanism of a computer media device 135, etc. Further, in addition to specifying a request to view a second item of media content 110, the input could, e.g., based on a key or button selected in the control 150, etc., indicate that the first item of media content 110 is to be paused for possible further playback from the data store 140. Such input may be referred to as a “swap request,” i.e., a request to change from viewing a first item of media content 110 to a second item of media content 110. Further, input indicating a swap request may not be required; the media device 135 could be configured to implement a swap request, e.g., as described below with respect to a block 520 and following blocks, whenever input is received to change from viewing a first item of media content 110 to viewing a second item of media content 110.

In any event, if a swap request is not identified in the block 510, then the process 500 proceeds to a block 515. In the block 515, the media device 135 determines whether the process 500 should continue. For example, the media device 135 could be powered off, input could be received to stop playback of all items of media content 110, etc. If it is determined that the process 500 should not continue, then the process 500 ends following the block 515. Otherwise, the process 500 returns to the block 505 following the block 515.

If a swap request is identified in the block 510, then the process 500 proceeds to a block 520. In the block 520, the media device identifies a swap location 205 in the prior or first item of media content 110, i.e., the item of media content 110 being viewed or displayed when a swap request was received.

Next, in a block 525, the media device 135 plays a selected second item of media content 110, i.e., the item of media content 110 indicated in a swap request identified in the block 510. When the block 525 is visited following the block 520, the media device 135 begins playback of the requested second item of media content 110 at a swap location 205. When the block 525 is visited following the block 545 (discussed below), the media device 135 simply continues to stream the media content 110. Further, the second item of media content 110 is stored in a buffer or the like of the data store 140.

Next, in a block 530, which may be omitted in some implementations, the media device 135 determines whether to provide an alert or message concerning the prior item of media content 110. For example, as mentioned above, the media device 135 could monitor a stream of the prior item of media content 110 to determine when an end of a hop portion 405 has been reached. Further, the media device 135 could provide an alert or message, e.g., via the display 145, indicating that the end of the hop portion 405, e.g., an end of a commercial break, has been reached. If an alert or message is indicated, then the process 500 proceeds to the block 535. Otherwise, the process 500 proceeds to a block 540.

In the block 535, the media device 135 provides, e.g., via the display 145, an alert or message as determined in the block 530. For example, a message could state “The commercial interruption in the football game you are watching is over. Press the SWAP key to return to the game.” Following the block 535, the process 500 returns to the block 525.

In the block 540, similar to the block 510, the media device 135 determines whether a swap request has been received. If so, a block 545 is executed next. Otherwise, a block 550 is executed next.

In the block 545, similar to the block 515 discussed above, the media device 135 determines whether the process 500 should continue. If not, then the process 500 ends following the block 545. Otherwise, the process 500 returns to the block 525.

In the block 550, which may follow the block 540, the media device 135 determines whether an item of media content 110 indicated in the swap request received in the block 540 is newly requested or has been previously played during a current execution of the process 500. That is, if the requested item of media content 110 has been previously played, then it will have been stored in the data store 140, and a swap location 205 will have been likewise stored. As explained above, playback of a previously played and paused item of media content 110 may be resumed at a swap location 205. On the other hand, if a new channel or item of media content 110 has been requested, i.e., the item of media content 110 has not been stored in the data store 140, then the media device 135 generally begins playback of the new item of media content 110 at a currently streaming location. Accordingly, if the requested item of media content 110 is not a previously played item of media content 110, but instead is a new item of media content 110, i.e., is not stored in the data store 140, then the process 500 proceeds to the block 520. However, if the requested item of media content 110 has been previously played, then the process 500 proceeds to a block 555.

In the block 555, the media device 135 identifies a resume location 215a in the requested item of media content 110. As discussed above, such a resume location 215a may be identified according to a swap location 205, e.g., that may be determined as described above with respect to the block 520. As also discussed above, a resume location 215a may alternatively be identified according to an end location of a hop portion 405.

Following the block 555, in a block 560, the media device 135 begins playback of the requested item of media content 110 beginning at the resume location 215a identified in the block 555. Further, storage of the item of media content 110 in the data store 140 continues. Following the block 560, the process 500 proceeds to the block 530.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A media device that includes a processor and a memory, the media device configured to:
pause play of a first item of media content while continuing to receive and store the first item of media content;
while playing a second item of media content, receive a request to play the first item of media content;
identify a location in the first item of media content at which play is to be resumed; and
resume play of the first item of media content at the location in the first item of media content.

2. The media device of claim 1, wherein the media device is further configured to:
while playing the second item of media content, receive a request to play a third item of media content;
determine whether a location for resuming play of the third item of media content is stored;
if a location for resuming play of the third item of media content is stored, resume play of the third item of media content at the location in the third item of media content; and
if a location for resuming play of the third item of media content is not stored, begin play of the third item of media content at a current location in the third item of media content.

3. The media device of claim 1, wherein the location in the first item of media content at which play is to be resumed is a location at which the first item of media content was paused.

4. The media device of claim 1, wherein the media device is further configured to identify a hop portion in the first item of media content, and further wherein the location in the first item of media content at which play is to be resumed is determined according to the hop portion.

5. The media device of claim 4, further configured to provide an alert when an end location of the hop portion is reached in the first item of media content.

6. The media device of claim 1, wherein the first item of media content and the second item of media content are formatted according to a standard of the motion picture experts group (MPEG).

7. The media device of claim 1, wherein the media device includes at least one of a television, a computer, and a set top box.

8. A media device that includes a processor and a memory, the media device configured to:
while playing a first item of media content, receive a request to play a second item of media content;
determine whether a location for resuming play of the second item of media content is stored;
if a location for resuming play of the second item of media content is stored, resume play of the second item of media content at the location in the second item of media content; and
if a location for resuming play of the second item of media content is not stored, begin play of the second item of media content at a current location in the second item of media content.

9. The media device of claim 8, further configured to:
while playing the second item of media content receive a request to play a third item of media content;
determine whether a location for resuming play of the third item of media content is stored;
if a location for resuming play of the third item of media content is stored, resume play of the third item of media content at the location in the third item of media content; and
if a location for resuming play of the third item of media content is not stored, begin play of the third item of media content at a current location in the third item of media content.

10. The media device of claim 8, wherein the location in the second item of media content at which play is to be resumed is a location at which the second item of media content was paused.

11. The claim 8, wherein the media device is further configured to identify a hop portion in the second item of media content, and further wherein the location in the second item of media content at which play is to be resumed is determined according to the hop portion.

12. The media device of claim 11, further configured to provide an alert when an end location of the hop portion is reached in the second item of media content.

13. The media device of claim 8, wherein the first item of media content and the second item of media content are formatted according to a standard of the motion picture experts group (MPEG).

14. The media device of claim 8, wherein the media device includes at least one of a television, a computer, and a set top box.

15. A method, comprising:
while playing a first item of media content, receiving a request to play a second item of media content;
determining whether a location for resuming play of the second item of media content is stored;
if a location for resuming play of the second item of media content is stored, resuming play of the second item of media content at the location in the second item of media content; and
if a location for resuming play of the second item of media content is not stored, beginning play of the second item of media content at a current location in the second item of media content.

16. The method of claim 15, further comprising:
while playing the second item of media content, receiving a request to play a third item of media content;
determining whether a location for resuming play of the third item of media content is stored;
if a location for resuming play of the third item of media content is stored, resuming play of the third item of media content at the location in the third item of media content; and
if a location for resuming play of the third item of media content is not stored, beginning play of the third item of media content at a current location in the third item of media content.

17. The method of claim 15, wherein the location in the second item of media content at which play is to be resumed is a location at which the second item of media content was paused.

18. The method of claim 15, further comprising identifying a hop portion in the second item of media content, and determining the location in the second item of media content at which play is to be resumed is according to the hop portion.

19. The method of claim 18, further comprising providing an alert when an end location of the hop portion is reached in the second item of media content.

20. The method of claim 15, further comprising formatting the first item of media content and the second item of media content according to a standard of the motion picture experts group (MPEG).
